(19) United States
(12) Patent Application Publication
(10) Pub. No.: US 2013/0232134 A1
(43) Pub. Date: Sep. 5, 2013

(54) Presenting Structured Book Search Results

(71) Applicants: Frances B. Haugen, Mountain View, CA (US); Matthew K. Gray, Reading, MA (US)

(72) Inventors: Frances B. Haugen, Mountain View, CA (US); Matthew K. Gray, Reading, MA (US)

(21) Appl. No.: 13/768,715

(22) Filed: Feb. 15, 2013

Related U.S. Application Data
(60) Provisional application No. 61/600,528, filed on Feb. 17, 2012.

(51) Int. Cl. G06F 17/30

(52) U.S. Cl. CPC G06F 17/30554
USPC 707/722

(57) ABSTRACT

Methods, systems, and apparatus, including computer programs encoded on a computer storage medium, for presenting book search results. A query is received requesting a search of text of a book resource. A presentation of search results that satisfy the query is generated, wherein each of the search results identifies a portion of the book resource, the presentation comprising one or more section headings each corresponding to a respective section of the book resource in which a portion identified by at least one search result occurs, and, search results associated with the corresponding section, each search result associated with a location within the corresponding section, each search result including a snippet of text from the book resource that includes one or more terms of the query, and wherein each search result includes a link to an image of a scanned page of the book in which the snippet of text occurs.

### CROSS-REFERENCE TO RELATED APPLICATION

This application claims the benefit under 35 U.S.C. §119(e) of pending U.S. Patent Application No. 61/600,528, entitled “Presenting Structured Book Search Results”, filed Feb. 17, 2012, which is incorporated by reference herein in its entirety.

### BACKGROUND

This specification relates to providing information relevant to user search queries.

Internet search engines identify resources, e.g., web pages, images, text documents, and multimedia content, in response to queries submitted by users and present information about the resources in a manner that is intended to be useful to the users.

### SUMMARY

This specification describes technologies relating to presenting search results for book resources in which the search results take into account the internal structure of the book. The search results can be organized according to section divisions within the book and can include n-gram summary terms extracted from text of the book. Alternatively, the search results can be organized by the extracted n-gram summary terms.

In general, one innovative aspect of the subject matter described in this specification can be embodied in methods that include the actions of receiving a query requesting a search of text of a book resource, wherein the text of the book resource is obtained from a scanned copy of a printed book, wherein the query includes one or more terms; generating a presentation of search results that satisfy the query, wherein each of the search results identifies a portion of the book resource, the presentation comprising one or more section headings each corresponding to a respective section of the book resource in which a portion identified by at least one search result occurs, wherein the one or more section headings are presented in an order corresponding to an order in which the sections occur in the book resource, and, under each section heading, one or more search results associated with the corresponding section, each search result associated with a location within the corresponding section, each search result including a snippet of text from the book resource that includes one or more terms of the query, and wherein each search result includes a link to an image of a scanned page of the book in which the snippet of text occurs; and providing the presentation of search results in response to the query. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. The actions include determining the one or more section headings from the scanned copy of the printed book. Each search result includes a page number of the printed book. The section headings include one or more section headings corresponding to book chapters and having a section title that includes a title of the corresponding book chapter. The presentation further includes a presentation of n-grams extracted from the text of the book resource. The presentation of each n-gram includes a link, and wherein selection of a link for an n-gram initiates a search of the book resource with a query including the n-gram. The actions include computing a section score of each of one or more n-grams in each section of the book resource in which each n-gram occurs; computing a book score for each distinct n-gram using each section score for the n-gram; and ordering the n-grams by computed book score.

In general, another innovative aspect of the subject matter described in this specification can be embodied in methods that include the actions of receiving a request for a book resource; generating one or more queries, each query including a distinct n-gram extracted from text obtained from a scanned copy of a printed book corresponding to the book resource; generating a presentation of search results that satisfy each of the one or more generated queries, wherein each of the search results identifies a portion of the book resource, the presentation comprising one or more headings each corresponding to one of the one or more n-grams, wherein the one or more headings are presented in an order corresponding to a computed book score, and, a group of one or more search results with each heading, each group associated with the corresponding query, each search result associated with a location within the printed book, each search result including a snippet of text from the book resource that includes one or more terms of the corresponding query, and wherein each search result includes a link to an image of a scanned page of the printed book in which the snippet of text occurs; and providing the presentation of search results in response to the query. Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. Each search result includes a page number of the printed book. Each heading includes text of the n-gram. The actions include computing a section score for each of the one or more n-grams in each section of the book resource in which each n-gram occurs; computing a book score for each distinct n-gram using each section score for the n-gram; ranking the n-grams by computed book scores; and obtaining search results for each of one or more highest-ranked n-grams, wherein generating the presentation of search results comprises generating the presentation of search results using the obtained search results for each of the one or more highest-ranked n-grams. The section score for an n-gram is a term frequency-inverse document frequency score for the n-gram in each section of the book resource in which the n-gram occurs. The book score for each n-gram is based at least in part on a sum of each section score for the n-gram. The book score for each n-gram is based at least in part on a rank of the n-gram in each section according to the section score.

In general, another innovative aspect of the subject matter described in this specification can be embodied in methods that include the actions of obtaining text of a scanned copy of a printed book, the text being divided into sections corresponding to sections in the printed book; computing a section score for each of a plurality of n-grams in each section of the printed book in which each n-gram occurs; computing a book score for each distinct n-gram using each section score for the n-gram; and providing a list of n-grams ordered by the respective computed book scores of the n-grams. Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. Each section score for an n-gram is a term frequency-inverse document frequency score for the n-gram in each section of the printed book in which the n-gram occurs. The book score for each n-gram is based at least in part on a sum of term frequency-inverse document frequency scores for the n-gram for each section. The book score for each n-gram is based at least in part on a sum of each section score for each n-gram in each section. The book score for each n-gram is based at least in part on a rank of each n-gram in each section by section score. The book score is based at least in part on an inverse of a sum of inverse section scores for each n-gram in each section. The book score is defined by:

$$book\_score = K \cdot \frac{1}{{\sum }_{i = 1}^{N} \frac{1}{{score}_{i}}} ,$$

for each section score i in each of N sections, and wherein K is a constant. The book score for an n-gram is defined by:

$$book\_score = \frac{Cm + Rv}{m + v} ,$$

wherein C is an average book score of an n-gram, m is an average number of sections in which an n-gram occurs, R is an average of the computed section scores for the n-gram, and v is a number of sections in which the n-gram occurs. Providing the list of n-grams comprises providing the list of n-grams as a list of query suggestion links for searching text of the scanned copy of the printed book.

In general, another innovative aspect of the subject matter described in this specification can be embodied in methods that include the actions of receiving a query that identifies a digital book resource, the book resource having book text, the book text being partitioned into book sections; determining a plurality of n-gram summary terms from the book text; computing a section score for each of the n-gram summary terms for each of the book sections in which each of the n-gram summary terms occurs; computing a book score for each n-gram summary term from the section score for the n-gram summary term; ranking the n-gram summary terms according to the respective book scores for the n-gram summary terms to identify one or more highest-ranked n-gram summary terms; generating a plurality of summary term queries, each summary term query including a distinct one of the highest-ranked n-gram summary terms; generating a presentation of search results, each search result satisfying a corresponding one of the summary term queries, each search result identifying a portion of the book resource that includes an occurrence of the corresponding n-gram summary term, the presentation comprising one or more headings, each of the headings corresponding to one of the highest-ranked n-gram summary terms, and a group of one or more search results with each heading, the search results in each group being search results satisfying the corresponding summary term queries; and providing the presentation of search results in response to the query. Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. The one or more section headings are presented in an order according to a book score of the corresponding n-gram summary terms. Each search result includes a snippet of text from the book resource that includes one or more terms of the corresponding query. Each search result includes a link to an image of a scanned page of the printed book in which the snippet of text occurs. A section score for an n-gram occurring in a section is a term frequency-inverse document frequency score for occurrences of the n-gram in the section. The book score for each n-gram is based at least in part on a sum of each section score for the n-gram. The book score for each n-gram is based at least in part on a rank of the n-gram in each section according to the section score. The book score is based at least in part on an inverse of a sum of inverse section scores for each n-gram in each section. The book score is defined by:

$$book\_score = K \cdot \frac{1}{{\sum }_{i = 1}^{N} \frac{1}{{score}_{i}}} ,$$

for each section score i in each of N sections, and wherein K is a constant. The book score for an n-gram is defined by:

$$book\_score = \frac{Cm + Rv}{m + v} ,$$

wherein C is an average book score of the n-gram, m is an average number of sections in which the n-gram occurs, R is an average of the computed section scores for the n-gram, and v is a number of sections in which the n-gram occurs.

Particular embodiments of the subject matter described in this specification can be implemented so as to realize one or more of the following advantages. Organizing search results presentations by book sections provides users with an overview of corresponding internal structure within a book. Presenting a list of n-gram summary terms ranked by importance in the book provides users with a quick view of key issues and topics within the book. The list of n-gram summary terms can also aid users in discovering content in a particular book. N-gram summary terms can also be an aid in searching within a particular book.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an illustration of an example books search results page.

FIG. 2 is an illustration of an example system.

FIG. 3 is a flow chart of an example process for identifying a list of n-gram summary terms from the text of a book.

FIG. 4 is another illustration of an example presentation of books search results.

Like reference numbers and designations in the various drawings indicate like elements.

### DETAILED DESCRIPTION

Search systems provide access to many kinds of digital resources. Some search systems provide access to book resources, that is, resources that have been identified as relating specifically to digital or scanned versions of printed books and similar publications, e.g., magazines and journals. In response to a search query, the search system can provide search results that identify book resources for publications matching the search query.

Many types of book resources are structured in a particular way, e.g., by chapter. Search systems can use the structure of a particular book resource in order to obtain and present information about the book resource in an intuitive and accessible way.

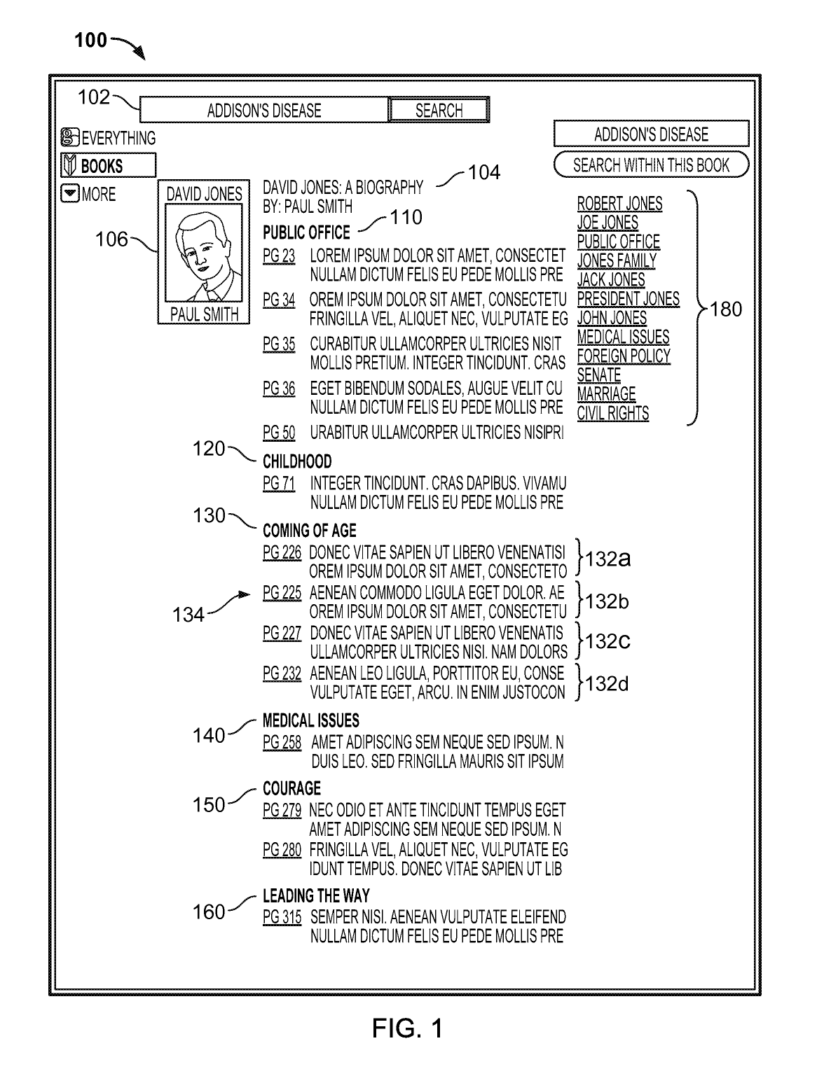

FIG. 1 is an illustration of an example books search results page 100. The search results page 100 is an example presentation of information about a book resource, a presentation that uses the internal structure of the book resource. The search results page 100 is generated and provided by a search engine in response to a user search query of one or more terms.

The search results page 100 includes a search box 102 or “query box”, an identification of the title and author 104 of the book resource, and an image 106 of the cover of the book resource.

The search results page 100 includes section headings, e.g., section headings 110, 120, 130, 140, 150, and 160, that correspond to sections in the book resource. Each section heading can correspond to a title of a section in the book resource. For example, each section heading can correspond to the title of a chapter, section, or other subsection of a particular book resource.

The search results page 100 can also present hierarchical section headings in which section headings are followed by corresponding subsection headings. In some implementations, the section headings are presented in an order that corresponds to an order in which the sections occur in the book resource. In some other implementations, section headings are ordered by computed scores of associated search results. The search results page 100 can also include search results from multiple book resources, in which case the title of a book resource can be presented as a corresponding section heading.

One or more search results are presented under each section heading, for example, search results 132a-d. Each search result 132a-d identifies a portion of the book resource in which one or more of the terms of the search query occur. Each search result 132a-d also includes a snippet of text from the identified portion of the book resource. In some implementations, the terms of the search query are highlighted in the snippet. The search results presented with each section heading can be presented in an order in which the terms of the query occur in the book resource.

Each search result also includes a hyperlink, or link, 134 to the book resource. Each link can include as display text a page number corresponding to the particular search result. In some implementations, a selection, for example, a click or mouseover, of the link causes a program displaying the page 100 to navigate to a page containing text or an image of a scanned page of the book or publication where the text of the snippet is located, or to provide in the text or the image in another way, for example, in a popup window.

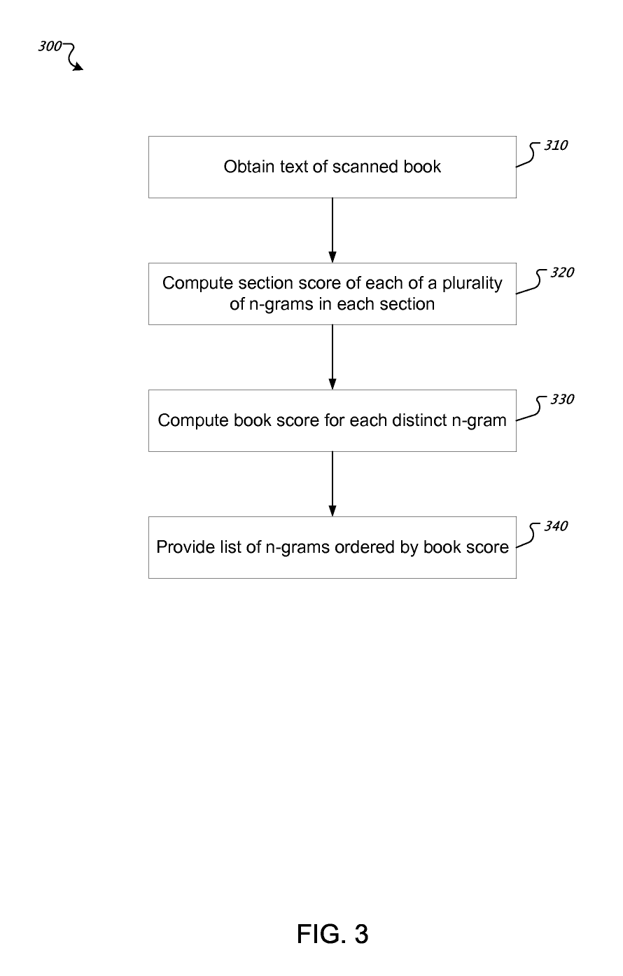

The search results page 100 also includes a presentation 180 of n-gram summary terms extracted from text of the book resource. The n-gram summary terms can be used by a user as summary information or as suggested search queries, in addition to other uses. In some implementations, each n-gram includes a link, and selection of the link of an n-gram summary term by a user initiates a search of the book resource with a query that includes the n-gram. Generation of the list of n-gram summary terms will be described in more detail with reference to FIG. 3.

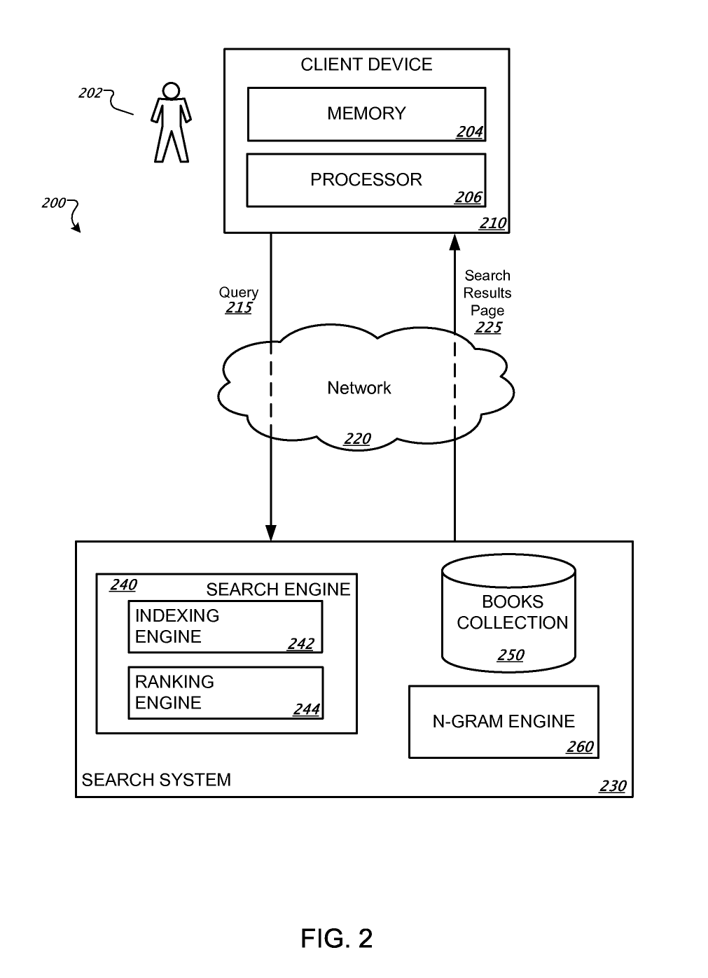

FIG. 2 is an illustration of an example system 200. The system 200 includes a user device 210 in communication with a search system 230 over a network 220. The search system 230 is an example of an information retrieval system in which the systems, components, and techniques described in this specification can be implemented.

A user device 210 can communicate with the search system 230 through a data communication network 220. In general, the user device 210 runs a program, e.g., a web browser, that transmits a query 215 over the network 220 to the search system 230. The search system 230 identifies resources that satisfy the query 215 and generates a search results presentation 225. The search system 230 transmits the search results presentation 225 over the network 220 back to the user device 210 for presentation to a user 202. Generally, the user 202 is a person.

The user device 210 can be any appropriate type of computing device, e.g., a server, mobile phone, tablet computer, notebook computer, music player, e-book reader, laptop or desktop computer, PDA (personal digital assistant), smart phone, or other stationary or portable device, that includes one or more processors 206 for executing program instructions and memory 204. The user device 210 can include computer readable media that store software applications, e.g., a browser or layout engine, an input device, e.g., a keyboard or mouse, a communication interface, and a display device.

The network 220 can be, for example, a wireless cellular network, a wireless local area network (WLAN) or Wi-Fi network, a Third Generation (3G), Fourth Generation (4G), or other mobile telecommunications network, a wired Ethernet network, a private network such as an intranet, a public network such as the Internet, or any suitable combination of such networks.

The search system 230 can be implemented as one or more computer programs installed on one or more computers in one or more locations that are coupled for data communication with each other. The search system 230 includes a search engine 240, a books collection 250, and an n-gram engine 260.

When the query 215 is received by the search system 230, a search engine 240 identifies resources that satisfy the query 215. The search engine 240 generally includes a ranking engine 244 to rank the resources that have been identified. The search engine will also include an indexing engine 242 that indexes resources in a collection, e.g., books, magazines, newspapers, web pages, or images. The indexing and ranking of resources can be performed using conventional techniques.

For example, book resources can be stored in books collection 250 for indexing by the indexing engine 242. The books collection can include, for example, scanned images of book pages and corresponding text. The search system 230 can obtain the corresponding text by performing optical character recognition on each scanned book page. The search system 230 can also analyze scanned pages of the book to identify section headings of the book, for example, by analyzing font size, font style, page layout, or page spacing.

The search system can also populate the books collection 250 by crawling available resources and downloading text of digitized books.

The search system 230 responds to the query 215 by generating a search results presentation 225, which is transmitted over the network 220 to the user device 210 in a form that can be presented on the user device 210, e.g., as a web page displayed in a web browser on the user device 210. For example, the search results presentation 225 can be a markup language document, e.g., HyperText Markup Language or eXtensible Markup Language document. The user device 210 renders the document, e.g., using a web browser, and presents the search results presentation 225 on a display device.

The search results presentation 225 can include a list of n-gram summary terms, e.g., the list 180 of n-gram summary terms as shown in FIG. 1. In order to generate the list of n-gram summary terms, the search system 230 can use an n-gram engine 260. The n-gram engine 260 can analyze text of a particular book resource in order to determine an ordering of n-grams according to a particular ranking model. In some implementations, the ranking model is designed to identify n-grams that provide good summary data for the contents of a book resource. The ranking model can also be designed to identify n-grams that provide useful search query suggestions to users.

FIG. 3 is a flow chart of an example process 300 for determining a list of n-gram summary terms from the text of a book resource. The process 300 can be implemented by one or more computer programs installed on one or more computers. The process 300 will be described as being performed by an n-gram engine, for example, the n-gram engine 260 of FIG. 2.

The n-gram engine obtains text of a scanned book (310). The text can be obtained from a collection of book resources. The book resources can include scanned pages of books and other publications, and can include corresponding text obtained, for example, through optical character recognition.

The book resource can be divided into sections and subsections corresponding to sections and subsections of the corresponding book or publication, for example, chapters. In other words, a particular portion of the book resource can be designated as a particular section of a corresponding book, e.g., Chapter 1. The sections can be identified using page layout analysis of scanned pages of a book or publication during, for example, an ingestion process that includes performing optical character recognition on the scanned pages.

In some implementations, the n-gram engine limits the analyzed text to pages that correspond to a particular set of search results or to pages of the book that include one or more terms of a particular search query.

The n-gram engine computes a section score of each of a plurality of n-grams in each section (320). The system can identify a number of n-grams to analyze from text of the scanned book. In some implementations, the system analyzes all n-grams occurring the text of the book below a particular n-gram order, e.g. all n-grams below n-gram order 3 or 4.

The section score for a particular n-gram can be based on a statistical measure of importance of occurrences of the n-gram in a section. For example, the n-gram engine can use a term frequency-inverse document frequency (“tf-idf”) measure to determine importance for each n-gram in a section. In some implementations, the term frequency “tf” component of the section score is the frequency of the n-gram within the section, and the inverse document frequency “idf” component is based on the number of sections of the book resource in which the n-gram occurs. For example, the inverse document frequency of an n-gram x can be computed as:

$$idf ( x ) = log \frac{\vert S \vert}{\vert \{ s : x ∈ s \} \vert} ,$$

where |S| is the number of sections in the book resource, and |{s:xεs}| is the number of sections that contain the n-gram x. The “tf-idf” measure can then be computed by multiplying the term frequency by the inverse document frequency. Other variations of the “tf-idf” measure can also be used.

The n-gram engine computes a book score for each distinct n-gram (330). The book score is generally based on the individual computed section scores for each n-gram. The book score can be computed in a variety of ways. In some implementations, the n-gram engine can compute a sum of the section scores, e.g., the tf-idf scores for each section. The n-gram engine can also rank n-grams in each section by section score and use the rank of the n-gram, e.g. 1, 2, etc., in each section to compute the book score.

The book score can also be computed as an inverse of a sum of inverse section scores. In other words, the inverses of the section scores are summed, and the book score is based on the inverse of the sum. For example, the book score can be defined by:

$$book\_score = K \cdot \frac{1}{{\sum }_{i = 1}^{N} \frac{1}{{score}_{i}}} ,$$

for each section score scoreᵢ in each of N sections, where K is a predetermined constant that can be used to scale the book score.

The book score can also be based on a Bayesian average defined by:

$$book\_score = \frac{Cm + Rv}{m + v} ,$$

where C is an average book score of all n-grams, m is an average number of sections in which an average n-gram occurs, R is an average of the computed section scores for the n-gram, and v is a number of sections in which the n-gram occurs.

The n-gram engine can also boost a book score for n-grams that are the names of particular entities, for example known cities or names of well-known people. For example, the book score of the n-gram “David Jones” can be given a boost because the n-gram is the name of a particular person.

The book score for a particular n-gram can also be influenced by how tightly clustered the particular n-gram is in the book text. The n-gram engine can accordingly boost the book score of n-grams that are more tightly clustered. In some implementations, the n-gram engine finds the shortest sequence of book terms that includes the n-gram a particular number of times. For example, the n-gram engine can determine that a particular n-gram occurred 5 times in a sequence of only 100 book terms. The n-gram engine can also use a sliding window of terms of a particular size and determine how often a particular n-gram occurs more than threshold number of times, e.g. more than 5 times. By boosting the book scores of n-grams that are more tightly clustered, the system can score an n-gram that occurs in a detailed discussion higher than another n-gram that is merely mentioned in passing or is spread evenly throughout a chapter or throughout the book. In some implementations, a presentation of search results can be ordered within a presented section heading by a measure of how tightly clustered a corresponding n-gram is for each identified search result for that section.

The n-gram engine provides the list of n-gram summary terms ordered by respective computed book score of the n-gram summary terms (340). After computing a book score for each n-gram, the n-gram engine can rank the n-grams by book score. In some implementations, a list of the highest-ranked n-grams is provided as the list of n-gram summary terms. The n-gram summary terms can be provided as summary data for a book or as a list of query suggestion links.

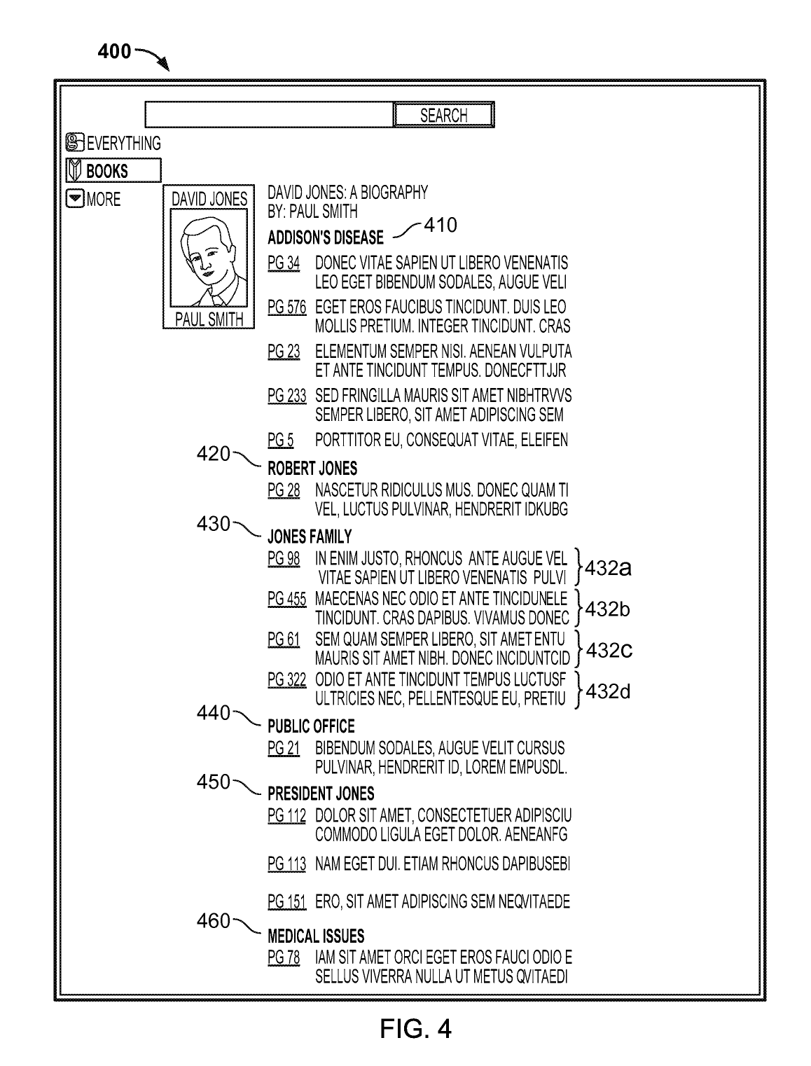

FIG. 4 is another illustration of an example presentation 400 of books search results. In FIG. 4, the headings 410, 420, 430, 440, 450, and 460 each correspond to an n-gram summary term as identified, for example, by the process 300 of FIG. 3. Each section heading can include one or more search results, for example, search results 432a-d.

The search system can generate one or more queries using a list of n-gram summary terms extracted from text of the corresponding book resource. Each query can include a distinct n-gram from the list of n-gram summary terms.

In some implementations, the search system performs a search within a book resource using the generated queries. The system then provides a number of highest-ranked n-gram summary terms as headings. Each heading can be presented with one or more search results that each identify a portion of the book resource that includes the corresponding n-gram summary term.

The search results presented for, and generally under, each heading can be ordered by location of occurrence within the book resource. The search results presented for each heading can alternatively be ordered by any other appropriate measure, including a measure of how tightly clustered each corresponding n-gram summary term occurs within text identified by each search result.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

The term “engine” refers to one or more software modules implemented on one or more computers in one or more locations that collectively provide certain well defined functionality, which is implemented by algorithms implemented in the modules. The software of an engine can be an encoded in one or more blocks of functionality, such as a library, a platform, a software development kit, or an object. An engine can be implemented on any appropriate types of computing devices, e.g., servers, mobile phones, tablet computers, notebook computers, music players, e-book readers, laptop or desktop computers, PDAs, smart phones, or other stationary or portable devices, that includes one or more processors and computer readable media. Additionally, two or more engines may be implemented on the same computing device or devices.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving a query requesting a search of text of a book resource, wherein the text of the book resource is obtained from a scanned copy of a printed book, wherein the query includes one or more terms;
generating a presentation of search results that satisfy the query, wherein each of the search results identifies a portion of the book resource, the presentation comprising:
one or more section headings each corresponding to a respective section of the book resource in which a portion identified by at least one search result occurs, wherein the one or more section headings are presented in an order corresponding to an order in which the sections occur in the book resource, and,
under each section heading, one or more search results associated with the corresponding section, each search result associated with a location within the corresponding section, each search result including a snippet of text from the book resource that includes one or more terms of the query, and wherein each search result includes a link to an image of a scanned page of the book in which the snippet of text occurs; and
providing the presentation of search results in response to the query.

2. The method of claim 1, further comprising:
determining the one or more section headings from the scanned copy of the printed book.

3. The method of claim 1, wherein each search result includes a page number of the printed book.

4. The method of claim 1, wherein the section headings include one or more section headings corresponding to book chapters and having a section title that includes a title of the corresponding book chapter.

5. The method of claim 1, wherein the presentation further includes a presentation of n-grams extracted from the text of the book resource.

6. The method of claim 5, wherein the presentation of each n-gram includes a link, and wherein selection of a link for an n-gram initiates a search of the book resource with a query including the n-gram.

7. The method of claim 5, further comprising:
computing a section score of each of one or more n-grams in each section of the book resource in which each n-gram occurs;
computing a book score for each distinct n-gram using each section score for the n-gram; and
ordering the n-grams by computed book score.

8. A system comprising:
one or more computers and one or more storage devices storing instructions that are operable, when executed by the one or more computers, to cause the one or more computers to perform operations comprising:
receiving a query requesting a search of text of a book resource, wherein the text of the book resource is obtained from a scanned copy of a printed book, wherein the query includes one or more terms;
generating a presentation of search results that satisfy the query, wherein each of the search results identifies a portion of the book resource, the presentation comprising:
one or more section headings each corresponding to a respective section of the book resource in which a portion identified by at least one search result occurs, wherein the one or more section headings are presented in an order corresponding to an order in which the sections occur in the book resource, and,
under each section heading, one or more search results associated with the corresponding section, each search result associated with a location within the corresponding section, each search result including a snippet of text from the book resource that includes one or more terms of the query, and wherein each search result includes a link to an image of a scanned page of the book in which the snippet of text occurs; and
providing the presentation of search results in response to the query.

9. The system of claim 8, wherein the operations further comprise:
determining the one or more section headings from the scanned copy of the printed book.

10. The system of claim 8, wherein each search result includes a page number of the printed book.

11. The system of claim 8, wherein the section headings include one or more section headings corresponding to book chapters and having a section title that includes a title of the corresponding book chapter.

12. The system of claim 8, wherein the presentation further includes a presentation of n-grams extracted from the text of the book resource.

13. The system of claim 12, wherein the presentation of each n-gram includes a link, and wherein selection of a link for an n-gram initiates a search of the book resource with a query including the n-gram.

14. The system of claim 12, wherein the operations further comprise:
computing a section score of each of one or more n-grams in each section of the book resource in which each n-gram occurs;
computing a book score for each distinct n-gram using each section score for the n-gram; and
ordering the n-grams by computed book score.

15. A computer program product, encoded on one or more non-transitory computer storage media, comprising instructions that when executed by one or more computers cause the one or more computers to perform operations comprising:
receiving a query requesting a search of text of a book resource, wherein the text of the book resource is obtained from a scanned copy of a printed book, wherein the query includes one or more terms;
generating a presentation of search results that satisfy the query, wherein each of the search results identifies a portion of the book resource, the presentation comprising:
one or more section headings each corresponding to a respective section of the book resource in which a portion identified by at least one search result occurs, wherein the one or more section headings are presented in an order corresponding to an order in which the sections occur in the book resource, and,
under each section heading, one or more search results associated with the corresponding section, each search result associated with a location within the corresponding section, each search result including a snippet of text from the book resource that includes one or more terms of the query, and wherein each search result includes a link to an image of a scanned page of the book in which the snippet of text occurs; and
providing the presentation of search results in response to the query.

16. The computer program product of claim 15, wherein the operations further comprise:
determining the one or more section headings from the scanned copy of the printed book.

17. The computer program product of claim 15, wherein the section headings include one or more section headings corresponding to book chapters and having a section title that includes a title of the corresponding book chapter.

18. The computer program product of claim 15, wherein the presentation further includes a presentation of n-grams extracted from the text of the book resource.

19. The computer program product of claim 18, wherein the presentation of each n-gram includes a link, and wherein selection of a link for an n-gram initiates a search of the book resource with a query including the n-gram.

20. The computer program product of claim 18, wherein the operations further comprise:
computing a section score of each of one or more n-grams in each section of the book resource in which each n-gram occurs;
computing a book score for each distinct n-gram using each section score for the n-gram; and
ordering the n-grams by computed book score.
